(19) United States
(12) Patent Application Publication
(10) Pub. No.: US 2023/0234888 A1
(43) Pub. Date: Jul. 27, 2023

(54) ARTIFICIAL AGGLOMERATED MATERIAL

(71) Applicant: Cosentino Research & Development, S.L., (ES)

(72) Inventors: Lucia FRATTINI, Cantoria (ES); Adrian CENTELLES SANCHEZ, Cantoria (ES); David ESPINOSA IGLESIAS, Cantoria (ES)

(21) Appl. No.: 18/068,831

(22) Filed: Dec. 20, 2022

(30) Foreign Application Priority Data
Jan. 27, 2022 (ES) 223820671

(51) Int. Cl. C04B 26/18; C04B 18/02; C04B 20/10; C04B 14/04

(52) U.S. Cl. CPC C04B 26/18; C04B 18/022; C04B 20/1051; C04B 14/045

(57) ABSTRACT

The disclosure relates to an improved artificial agglomerated material comprising an inorganic filler, and organic resin and a mixture of silanes as coupling agent, to a method for the manufacture of said agglomerated material, as well as to a mixture of silanes to be used in the manufacture of said agglomerated material.

This application claims priority to European Application No. 22382067.1, filed Jan. 27, 2022; the contents of which is incorporated herein by reference in its entirety.

The disclosure relates to agglomerated materials for construction, decoration, and architecture, as well as to their composition, manufacture, and fabrication. For example, the disclosure is framed in the technological field of artificial materials or articles composed of granulated inorganic fillers selected from mineral, stone, vitreous and/or ceramic materials, and a hardened organic resin, especially those manufactured by means of a process that includes vacuum vibrocompaction and hardening of agglomerated mixtures.

Artificial agglomerated stone articles which frequently simulate natural stones, also known as engineered stone articles, are common in the construction, decoration, architecture, and design sectors. The processes for their manufacture at industrial scale are well established nowadays.

One of most popular artificial stone materials, highly appreciated by their aesthetic, hardness, and resistance to staining and wear, are the so-called quartz agglomerated surfaces. They are extensively used for countertops, claddings, floorings, sinks and shower trays, to name a few applications. They are more generally called artificial stones, and their applications partially overlap with the applications of natural stones such as marble or granite. They can be made simulating the colors and patterns in natural stone, or they might also have a totally artificial appearance, e.g. with bright red or fuchsia colors. The basis of their composition and the technology currently used for their manufacture dates back from the late 1970s, as developed by the Italian company Breton SpA, and which is nowadays commercially known in the sector under the name Bretonstone®. The general basic concepts hereof are described, for example, in the U.S. Pat. No. 4,204,820. In this production process, quartz stone granulate, sometimes mixed with synthetic cristobalite and/or other mineral granulates, having varied particle sizes, are firstly mixed with a hardenable binder, normally a liquid organic resin. The resulting mixture is homogenized and distributed into a temporary mold or alternatively onto a sheet of paper, where it is then compacted by vibrocompaction under vacuum and subsequently hardened.

A different sort of artificial agglomerate articles is the generally known ‘solid surfaces’. With this rather indefinite term, the industry refers to construction materials of hardened (mostly acrylic) organic resin with ATH (alumina trihydrate, bauxite) as predominant filler. Such products are produced by cast-molding the liquid acrylic resin and ATH flowable mixture, optionally together with vibration to remove air bubbles, and then heat hardening the casted layer. Due to the requirement of enough flowability to facilitate casting and air removal, the amount of liquid resin is normally not lower than 20 wt. % of the uncured mixture. In comparison with quartz surfaces, solid surfaces suffer from lower hardness and wear resistance, and are inferior when trying to mimic the appearance of natural stones (the user associates them with plastic composites, and not with natural stones).

Quartz and synthetic cristobalite, although being different materials, they have several common characteristics that make them ideal fillers for their application in the manufacture of durable agglomerated construction/decoration surfaces, such as high abundance and availability, hardness, translucency, color lightness and chemical inertness. However, they have at least one serious drawback. The fine fraction of respirable crystalline silica dust generated during the manufacture of the artificial agglomerated stone containing quartz or cristobalite, or when this agglomerated material is mechanically processed, possess an occupational health risk for workers or fabricators. Prolonged or repeated inhalation of the small particle size fraction of crystalline silica dust has been associated with pneumoconiosis (silicosis) and other serious diseases. To avoid this hazard, workers potentially exposed to high levels of the respirable fraction of crystalline silica dust are required to wear personal protection equipment (e.g., respirators with particle filter), to work under ventilation for efficient air renewal and to use measures which fight the source of the dust (e.g. processing tools with water supply or dust extraction).

A myriad of other mineral and non-mineral inorganic granulates have been described for their use in agglomerated materials, especially in the patent literature, such as porphyry, amorphous silica, ceramics, dolomite, basalt, carbonates, silicon metal, fly ash, shell particles, corundum, silicon carbide, among many others.

For example, the use of natural materials such as certain feldspars or synthetic silicates as alternatives to quartz and cristobalite has been described, such as in WO2021019020, WO2021018996, WO2021069464. These materials, if they comprise crystalline silica, it is at a significantly lower concentration than quartz or cristobalite.

Also widely known in the art is the use of vitreous inorganic granulates with a predominantly amorphous character, such as inorganic glasses (recycled or cullet, frits, beads, flakes, short fibers), in the manufacture of agglomerated artificial stone articles. Because of their amorphous character, these materials have comparatively low concentrations of crystalline silica.

To improve the compatibility and bond between the inorganic granulates and the hardened organic resin in artificial agglomerated stone articles, coupling agents (also called adhesion promoters or surface modifiers) are used. Mostly, silanes substituted with organic residues are used for this purpose. Basically, silane coupling agents have the ability to form a durable link between the surface of the inorganic granulates and the polymeric network formed by the hardened organic resin. Silanes used as coupling agents typically present at least one hydrolysable group which form silanol group after hydrolysis. The silanol group then reacts with the moieties in the surface of the inorganic granulates, e.g., forming siloxane linkages with the surface of silicate granules. Alternatively, the siloxane linkage might be formed by the reaction of the hydrolysable group with silanol groups already present at the surface of the inorganic granulates, without the hydrolyzation of the silane taking place first. Additionally, silanes normally comprise at least one less or non-hydrolysable group having a high affinity with the resin matrix. For instance, the less or non-hydrolysable group might comprise a functional group which reacts with and covalently bonds to the polymeric resin.

In the case of artificial agglomerated stones of the types described above, such as when quartz granulates are used, the compound 3-methacryloxypropyl-trimethoxysilane is used as coupling agent. When present as additive, it shows a significant improvement of many properties of the agglomerated article, such as surface abrasion resistance, hydrolysis resistance, color appreciation or mechanical performance, and it is readily commercially available at a competitive cost.

Documents EP1893678A1, CN107879676A and US2012283087A1 describe generally the use of 3-methacryloxypropyl-trimethoxysilane and other unsaturated silanes as coupling agents in quartz agglomerates with different types of resin.

WO2018185552A1 mentions a broad lists of silanes and silane mixtures for use in the manufacture of artificial stone.

However, there is still an ongoing need for improvements to help remedy any deficiencies or shortcomings found in the technique, that could result in artificial agglomerated products with improved properties, and/or that facilitate or enhance the output of their manufacture. This is the case, in particular but not only, when inorganic granules alternative to quartz or synthetic cristobalite are used in the artificial agglomerated products.

The disclosure is based on the finding by the inventors that both the properties of agglomerated articles, such as agglomerate artificial stones, and their manufacturing can be improved when a coupling agent derived from a silane mixture according to the claims is used.

Accordingly, in a first aspect the disclosure relates to an agglomerated material comprising an inorganic filler, a hardened organic resin, and a coupling agent, wherein the coupling agent results from the reaction of a mixture comprising Silane A and Silane B, wherein Silane A has the following formula:

Si(—OCOR¹)ₓ(—R²)_{y}

wherein

x is 1, 2 or 3,

y is 1, 2 or 3,

x+y is 4;

each R¹ is independently a group of formula CₙH₂ₙ₊₁, wherein n is 1, 2 or 3; and

each R² is independently selected from a group of formula CₘH₂ₘ₊₁, —OCₚH₂ₚ₊₁,

Ph, —O-Ph, —O—CH₂-Ph, and —CH₂-Ph, wherein m is 3, 4, 5 or 6 and p is 3, 4, 5 or 6;

and Silane B is an alkoxysilane or an acyloxysilane comprising a substituent, different from the alkoxy or acyloxy substituent(s), linked to the silicon atom and comprising a functional group capable of reacting with the organic resin.

In a second aspect, the disclosure relates to an agglomerated composition comprising an inorganic filler, an organic resin, Silane A and Silane B, wherein Silane A and Silane B are as defined in the first aspect.

In a third aspect, the disclosure is directed to the use of the composition of the second aspect in the manufacture of an agglomerated material.

In a fourth aspect, the disclosure relates to a mixture comprising Silane A and Silane B, or to a packaged mixture comprising Silane A and Silane B, such as for their use in the manufacture of an agglomerated material, wherein Silane A and Silane B are as defined in the first aspect.

In a fifth aspect, the disclosure is directed to the use of the mixture of the fourth aspect in the manufacture of an agglomerated material.

In a sixth aspect, the disclosure refers to a method for the manufacture of an agglomerated material, comprising:
i) mixing a composition comprising an inorganic filler, an organic resin, Silane A and Silane B, wherein Silane A and Silane B are as defined in the first aspect, to obtain an unhardened mixture,
ii) casting and/or compacting the unhardened mixture obtained in i), and
iii) hardening the compacted mixture obtained in ii).

In a seventh aspect, the disclosure is directed to an agglomerated material obtainable by the method defined in the sixth aspect.

### DESCRIPTION

It has been found that, when the combination of Silane A and Silane B is used in the agglomerated material or its manufacture, according to the different aspects and embodiments of the disclosure, at least the resistance to hydrolysis of the material is improved, for example when the inorganic filler comprises amounts of silicates or aluminosilicates such as feldspar or glass. A hydrolysis resistance is a needed characteristic for agglomerated materials, primarily when they are used additionally as decorative article, such as a work or cladding surface, or similar. For those applications, the surface appearance and aesthetics, and the surface preservation during the whole life of the product (which normally reach 25 years or more) is of relevance. Hydrolysis caused by the effect of humidity or other chemicals, results in color deterioration (yellowing, whitening) or the degradation of the surface (appearance of porosity, susceptibility to scratching, among others).

Highly advantageously, simultaneously, the agglomerated material can be polished more vigorously, at higher speeds, reaching similar gloss level, and without the occurrence of critical defects. Thus, the manufacturing, and the surface finishing of the agglomerated material, can be conducted more efficiently and at higher rates.

Without wishing to be bound by any theory, the inventors hypothesize that Silane A works synergistically with Silane B to result in the mentioned improvements. The acyloxy (—OCOR) groups in Silane A would provide higher reactivity of the silane mixture, both with the inorganic fillers, with itself, and with Silane B. Furthermore, the hydrolysis of the acyloxy (—OCOR) groups generates in situ an organic acid (e.g., acetic acid), which may catalyze the hydrolysis of further alkoxy- or acyloxy-silane groups, and/or the creation of additional surface silanols in the inorganic fillers. The organic acid might also neutralize alkaline compounds available in the surface of the inorganic filles, such as alkaline (sodium) or alkaline-earth oxides. Simultaneously, the (—R²) groups in Silane A increase sufficiently the hydrophobicity of the silane network interphase created between the inorganic fillers and the organic resin to at least defer the ageing caused by humidity. In this hypothesis, Silane B might extensively react with the resin, with Silane A, and with the surface moieties in the inorganic fillers, assuring improved granulate anchoring and protecting this anchoring from deterioration by hydrolysis caused by humidity during the lifetime of the material.

The agglomerated material may be an artificial agglomerated stone, a solid agglomerate surface, a mineral agglomerated surface, or an engineered stone, as described herein and as such terms are generally understood in the technical field of the disclosure. For clarity purposes, but without intending to be limiting, the terms agglomerated stone or artificial agglomerated stone refer herein at least to all materials included in the definition contained in European standard EN 14618:2009, where the binder is a (hardened) resin.

The composition of the inorganic fillers might be obtained by X-ray fluorescence (XRF), a technique well-established in the mineral technological field.

The amount of crystalline phases, such as crystalline silica, in the agglomerated material and in the raw materials can be determined, e.g., by powder X-Ray Diffraction analysis (XRD), for example using the Rietveld method for quantification, a technique amply used in the field.

The skilled person readily understands that, when a composition or material is defined by the weight percentage values of all the components it comprises, these values can never sum up to a value which is greater than 100%. The amount of all components that said material or composition comprises adds up to 100% of the weight of the composition or material.

When the amount of a component of a composition, mixture or material is given by a range with a lower limit of 0 wt % or 0.0 wt %, this means that said composition, mixture or material may either not comprise said component or comprise it in an amount not higher than the specified upper limit of the range.

When a range is indicated in the present document, both lower and upper limits are included in said range.

In the present application, the disclosed percentages refer to w/w percentage unless otherwise stated.

The term “comprises” encompasses the terms “consisting essentially of” and “consisting of”. Thus, at each occurrence in the present application, the term “comprising” may be replaced with the term “consisting essentially of” or “consisting of”.

As used herein, the singular forms “a” “an” and “the” include plural reference unless the context clearly dictates otherwise.

Unless specifically stated otherwise, or unless they are clearly incompatible, all the embodiments disclosed in relation to an aspect of the disclosure are also applicable to the other aspects.

It should be understood that the scope of the present disclosure includes all the possible combinations of embodiments disclosed herein, either belonging to the same aspect or to different aspects of the disclosure.

A first aspect of the disclosure relates to an agglomerated material comprising an inorganic filler, a hardened organic resin, and a coupling agent, wherein the coupling agent results from the reaction of Silane A and Silane B.

It shall be understood that the coupling agent in the agglomerated material is formed by the reaction of a mixture comprising Silane A and Silane B, either with the inorganic filler, with the organic resin, and/or with themselves, during manufacture of the agglomerated material. Therefore, the coupling agent in the agglomerated material of the disclosure is the reaction product of Silane A and Silane B (e.g., with themselves and/or with the inorganic filler and/or with the organic resin) during the manufacture of the agglomerated material, in particular during hardening of a composition comprising the inorganic filler, the organic resin, Silane A and Silane B.

In another aspect, the disclosure relates to an (unhardened) agglomerated composition comprising an inorganic filler, an organic resin, Silane A and Silane B. In a further aspect, the disclosure is directed to the use of said composition in the manufacture of an agglomerated material, for example an agglomerated material comprising an inorganic filler and a hardened organic resin.

In another aspect, the disclosure refers to a mixture comprising Silane A and Silane B (silane mixture), or to a packaged mixture comprising Silane A and Silane B. In an aspect, the disclosure is directed to a package that comprises a mixture comprising Silane A and Silane B. In a further aspect, the disclosure is directed to the use of said mixture or said package in the manufacture of an agglomerated material, particularly an agglomerated material comprising an inorganic filler and a hardened organic resin.

### Silane A

Silane A is a compound with the following general formula:

Si(—OCOR¹)ₓ(—R²)_{y}

wherein

x is 1, 2 or 3,

y is 1, 2 or 3,

x+y is 4;

each R¹ is independently a group of formula CₙH₂ₙ₊₁, wherein n is 1, 2 or 3; and

each R² is independently selected from a group of formula CₘH₂ₘ₊₁, —OCₚH₂ₚ₊₁, Ph, —O-Ph, —O—CH₂-Ph and —CH₂-Ph, wherein m is 3, 4, 5 or 6 and p is 3, 4, 5 or 6.

Each R¹ is independently selected from a linear or branched C₁₋₃ alkyl group. That is, a group of formula CₙH₂ₙ₊₁, wherein n is 1, 2 or 3, such as methyl, ethyl, n-propyl or i-propyl.

When Silane A comprises more than one R¹ groups (x=2 or 3), each R¹ group may be different, or they may be the same. In an embodiment, all R¹ in Silane A are the same group.

In some embodiments, R¹ groups are methyl (n=1) and ethyl (n=2), so that the acyloxy group —OCOR is acetoxy or propionoxy, respectively.

In some embodiments, R¹ are acetoxy groups (i.e. n=1, R¹=methyl), since they are good leaving groups, making the Silane A more reactive, and their hydrolysis generates acetic acid, which catalyzes the hydrolysis reaction of further alkoxy or acyloxy groups.

Each R² is independently selected from i) a linear or branched C₃₋₆ alkyl group (such as n-propyl, i-propyl, n-butyl, i-butyl, s-butyl, t-butyl, t-pentyl), ii) a linear or branched C₃₋₆ alkoxyl group (such as n-propoxy, i-propoxy, n-butoxy, i-butoxy, t-butoxy, s-butoxy, t-pentoxy, ethylbutoxy), iii) a phenyl group (Ph) or a phenoxy group (—OPh), or iv) a benzyl group (—CH₂-Ph), or a benzyloxy group (—O—CH₂-Ph). That is, a group of formula CₘH₂ₘ₊₁ wherein m is 3, 4, 5 or 6, —OCₚH₂ₚ₊₁ wherein p is 3, 4, 5 or 6, Ph, —OPh, O—CH₂-Ph, or —CH₂-Ph.

When Silane A comprises more than one R² groups (y=2 or 3), each R² group may be different, or they may be the same. In an embodiment, all R² in Silane A are the same group.

In some embodiments, m and/or p are 3, 4 or 5.

In an embodiment, each R² is independently a group of formula —OCₚH₂ₚ₊₁ or —O—CH₂-Ph, such as n-propoxy, i-propoxy, n-butoxy, i-butoxy, t-butoxy, s-butoxy, t-pentoxy, ethylbutoxy, benzyloxy; such as t-butoxy or benzyloxy.

In an embodiment, each R² is independently a group of formula —OCₚH₂ₚ₊₁ with p=4, such as n-butoxy, i-butoxy, s-butoxy or t-butoxy, such as t-butoxy.

In an embodiment x=y=2.

In an embodiment, Silane A is a compound with the following general formula:

Si(—OCOR¹)ₓ(—R²)_{y}

wherein

x is 2,

y is 2,

each R¹ is independently a group of formula CₙH₂ₙ₊₁, wherein n is 1, 2 or 3; and

each R² is independently a group of formula —OCₚH₂ₚ₊₁, wherein p is 3, 4, 5 or 6.

In a further embodiment, each R¹ is independently selected from methyl and ethyl.

In a further embodiment, each R² is independently selected from i-propoxy, i-butoxy, t-butoxy, s-butoxy, t-pentoxy, ethylbutoxy, benzyloxy; such as, t-butoxy or benzyloxy.

In an embodiment, Silane A is selected from the group consisting of di-t-butoxy-diacetoxysilane, di-isobutoxy-diacetoxysilane, di-isopropoxy-diacetoxysilane, di-phenyl-di-acetoxysilane, di-phenoxy-di-acetoxysilane, di-benzyl-di-acetoxysilane, di-benzyloxy-di-acetoxysilane, di-t-butyl-diacetoxysilane, di-isobutyl-diacetoxysilane, di-isopropyl-diacetoxysilane, di-t-butoxy-dipropionoxysilane, di-isopropoxy-dipropionoxysilane, 2-ethylbutoxy-diacetoxysilane, di-t-pentoxy-diacetoxysilane, and mixtures thereof.

In some embodiments, Silane A is di-t-butoxy-diacetoxysilane, i.e., x=y=2, R¹=methyl (n=1) and R²=OtBu (p=4). Di-t-butoxy-diacetoxysilane is commercially readily available in large quantities from various silane manufacturers, and can be stored under dry conditions for several months without deterioration. Alternatively, Silane A may be di-benzyloxy-di-acetoxysilane, which is also commercially available.

### Silane B

Silane B is an alkoxysilane or an acyloxysilane comprising a substituent linked to the silicon atom, different to the alkoxy or acyloxy substituents, comprising a functional group capable of reacting with the organic resin. That is, it is a compound comprising one or more alkoxy and/or acyloxy substituents and, additionally, at least one substituent linked directly to the silicon atom comprising a functional group capable of reacting with the organic resin.

Silane B might have one, two or three groups, such as two or three, that are independently selected from —OR³ (alkoxy) and —OCOR³ (acyloxy), wherein each R³ is independently selected from C_{q}H_{2q+1}, wherein q is 1, 2, 3 or 4. Suitable —OR³ and —OCOR³ groups include methoxy, ethoxy, n-propoxy, i-propoxy, n-butoxy, i-butoxy, s-butoxy, t-butoxy, acetoxy and propionoxy.

In some embodiments, Silane B comprises two or three identical, alkoxy- or acyloxy-groups, and may be a dimethoxysilane, trimethoxysilane, diethoxysilane, triethoxysilane, dipropoxysilane, tripropoxysilane, diacetoxysilane, triacetoxysilane. For example, Silane B is a trimethoxysilane or a triethoxysilane.

At least one of the substituents in Silane B, e.g., one, linked directly to the silicon atom and being different from the alkoxy- or acyloxy-groups, comprises a functional group capable of reacting with the organic resin. By capable of reacting should be understood that the functional group undergoes a chemical reaction with groups present in the organic resin to form a covalent bond in the conditions available during the manufacture of the agglomerated material, and for example, although not necessarily exclusively, in the conditions during the hardening step. The functional group capable of reacting with the organic resin can be an unsaturated functional group (e.g., a double bond), an epoxy group or an anhydride group.

Therefore, in an embodiment, Silane B is an alkoxysilane or an acyloxysilane that further comprises at least one group, such as one, different from the alkoxy- or acyloxy-substituents, directly linked to the silicon atom that is substituted with an unsaturated functional group (e.g., a double bond), an epoxy group or an anhydride group. In an embodiment, Silane B comprises at least one group, such as one, directly linked to the silicon atom that is substituted with a functional group selected from vinyl, acryloxy, methacryloxy, epoxy and anhydride; such as a methacryloxy group. In an embodiment, at least one, such as one, of the substituents in Silane B, different from the alkoxy- or acyloxy-substituents, is a C₁₋₆ alkyl group substituted with a functional group selected from vinyl, acryloxy, methacryloxy, epoxy and anhydride; such as, it is a methacryloxypropyl group.

In some embodiments, the remaining substituents in Silane B, if any, different from the alkoxy- or acyloxy-substituents and the substituent that comprises a functional group capable of reacting with the organic resin, are selected from C₁₋₃ alkyl groups, such as methyl, ethyl, n-propyl and i-propyl.

Therefore, in an embodiment, Silane B is a silane comprising 1, 2 or 3, such as 2 or 3, alkoxy- or acyloxy-substituent(s), and 1, 2 or 3, such as 1, substituent(s) comprising a functional group capable of reacting with the organic resin. In an embodiment, it further comprises 0, 1 or 2, such as 0 or 1, substituent(s) selected from C₁₋₃ alkyl.

In an embodiment, Silane B is a compound with the following general formula:

Si(—ZR³)₃(-L-R⁴)

wherein
each Z is independently absent, —O—, or —OCO—, provided that at least one Z is selected from —O— and —OCO—;
each R³ is independently selected from a group of formula C_{q}H_{2q+1}, wherein q is 1, 2, 3 or 4;
L is a C₁₋₅ alkyl chain optionally interrupted by one oxygen atom;
R⁴ is selected from vinyl, acryloxy, methacryloxy, epoxy and anhydride.

At least one, i.e. one, two or three, of the Z groups in the above formula is selected from —O— and —OCO—, so that the compound is an alkoxy- or acyloxysilane.

In an embodiment, two or three of the Z groups are —O—, such as 3. In an embodiment, two or three of the Z groups are —O— and the other one is absent.

In a further embodiment, each R³ is independently selected from methyl (q=1) and ethyl (q=2), such as methyl.

In an embodiment, L is selected from a group of formula —CH₂—, —CH₂—CH₂—, —CH₂—CH₂—CH₂—, —CH₂—CH₂—CH₂—CH₂—, —CH₂—CH₂—CH₂—CH₂—CH₂—, —CH₂—CH₂—CH₂—O—CH₂— and —CH₂—CH₂—O—CH₂—.

In an embodiment, R⁴ is selected from a group of formula —CH═CH₂, —OCOCH═CH₂, —OCOC(CH₃)═CH₂,

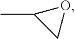

and —C(O)—O—C(O)—R⁵, wherein R⁵ is a group of formula CᵣH₂ᵣ₊₁, wherein r is 1, 2, 3 or 4.

In an embodiment, -L-R⁴ is selected from —(CH₂)₃—OCOCH═CH₂, —(CH₂)₃—OCOC(CH₃)═CH₂ and

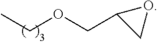

According, to an embodiment, Silane B is a dialkoxy- or trialkoxysilane further comprising a substituent directly linked to the silicon atom that is substituted with a methacryloxy group. In an embodiment, Silane B is a dialkoxy- or trialkoxysilane further comprising a substituent linked directly to the silicon atom that is substituted with a methacryloxypropyl group.

In some embodiments, Silane B is selected from dimethoxysilane, trimethoxysilane, diethoxysilane, triethoxysilane, dipropoxysilane and tripropoxysilane.

In an embodiment, Silane B is selected from 3-methacryloxypropyl-trimethoxysilane, 3-methacryloxypropyl-triethoxysilane, 3-methacryloxypropyl-methyldimethoxysilane and acryloxypropyl-trimethoxysilane. For example, Silane B is 3-methacryloxypropyl-trimethoxysilane.

In some embodiments, Silane B does not comprise any amino functional group.

It is generally known how to synthesize the different silanes according to the general formula of Silane A or Silane B. Also, many of them can be purchased as commercial products from large silane manufacturers such as Evonik Industries, Momentive, Gelest, or Wacker Chemie.

Other silanes or coupling agents might be used together with Silanes A and B, without departing from the inventive concept. In some embodiments, the agglomerated composition or the agglomerated material does not comprise other silanes and/or other coupling agents different from Silane A and Silane B.

The weight ratio of Silane A:Silane B in the agglomerated composition, in the mixture comprising Silane A and Silane B used to prepare the agglomerated material, or in the silane mixture according to the disclosure, may range from 1:99-99:1, or 5:95-95:5. In an embodiment, it ranges from 10:90-90:10. According to an embodiment, the weight ratio of Silane A:Silane B ranges from 5:95-75:25, or even 10:90-50:50.

In a further embodiment, the weight ratio of Silane A:Silane B in the agglomerated composition, in the mixture comprising Silane A and Silane B used to prepare the agglomerated material, or in the silane mixture according to the disclosure, ranges from 15:85-50:50. In another embodiment, the weight ratio of Silane A:Silane B ranges from 40:60 to 90:10, or even 30:70 to 90:10.

According to an embodiment, the amount of Silane A+Silane B (added weights) in the agglomerated composition (or used in the manufacture of the agglomerated material) is 0.02 wt. %-0.6 wt. %, or even 0.05 wt. %-0.4 wt. %, based on the total weight of the agglomerated composition (or based on the total weight of components used in the manufacture of the agglomerated material, e.g., the inorganic filler, organic resin, Silane A, Silane B and optionally additives). In another embodiment, the amount of Silane A+Silane B (added weights) in the agglomerated composition (or used in the manufacture of the agglomerated material) is 0.1 wt. %-0.6 wt. %, or even 0.15 wt. %-0.4 wt. %.

In an embodiment, the amount of Silane A+Silane B (added weights) in the agglomerated composition is 0.2 wt. %-6.0 wt. %, or even 0.5 wt. %-4.0 wt. %, in relation to the weight of organic resin in the agglomerated composition.

The disclosure is also concerned with a silane mixture comprising Silane A and Silane B, such as a packed mixture. The disclosure also refers to a package that comprises a silane mixture comprising Silane A and Silane B.

In some embodiments, Silane A, Silane B and their weight ratio in the silane mixture or packaged silane mixture are as disclosed herein, for example, in relation to other aspects of the disclosure. Said silane mixture may be contained in a packaging and may be suitable to be employed in the manufacture of an agglomerated material, for example, as those on the other aspects of the disclosure. The silane mixture may be contained in any appropriate packaging or containment, such as in a dry environment, to allow its safe transport and/or use. Appropriate packaging can be any of those known in the art for moisture sensible mixtures or silanes, e.g., sealed, and include cans, drums or IBCs (intermediate bulk containers). The packaged silane mixture of Silane A and Silane B may comprise stabilizing agents to extend its shelf-life, such as pH-regulators or hygroscopic compounds to remove water from the mixture. The amount of stabilizing agents might suitably range from 0.01 wt. %-1.0 wt. % of the weight of the mixture. In some embodiments, the weight of Silane A+Silane B (added weights) in the silane mixture or packaged silane mixture is 85 wt. %-100 wt %, or 90 wt. %-100 wt %, or even 95 wt. %-100 wt %, based on the total weight of the mixture.

The silane mixture comprising Silane A and Silane B might comprise other silanes or coupling agent precursors. Nevertheless, in a particular embodiment, said silane mixture does not comprise other silanes and/or coupling agent precursors different from Silane A and Silane B.

### Inorganic Filler

The inorganic filler may be present in the agglomerated composition or material in an amount ranging from 70 wt. %-95 wt. %, such as 80 wt. %-95 wt. % based on the weight of the agglomerated composition or material.

The inorganic filler is usually a mixture of inorganic filler materials and can be obtained from the crushing and/or grinding of natural or artificial materials.

The inorganic filler in the agglomerated composition or material may be natural, synthetic or a mixture thereof. Suitable inorganic fillers include stone, mineral, vitreous and/or ceramic materials, such as quartz, glass (e.g., silicate glass, borosilicate glass, sodium borosilicate glass, glass frit), silica sand, feldspathic sand, feldspar, granite, calcite, basalt, natural or synthetic cristobalite, dolomite, mirror, ceramics, glass-ceramics, and mixtures thereof.

In some embodiments, the agglomerated material comprises a low crystalline silica content. Therefore, from 30 wt. %-100 wt. %, such as from 40 wt. %-100 wt. %, of the inorganic filler in the agglomerated composition or material, based on the weight of the inorganic filler, is different from quartz, natural or synthetic cristobalite, and any other crystalline polymorphs of silica. In some embodiments, from 50 wt. %-100 wt. % or even from 60 wt. %-100 wt. %, of the inorganic filler in the agglomerated composition or material, based on the weight of the inorganic filler, is different from quartz, cristobalite and any other crystalline polymorphs of silica.

According to an embodiment, the inorganic filler comprises from 10 wt. %-100 wt. %, such as 20-100 wt. %, of inorganic materials different from quartz and cristobalite, based on the total weight of the inorganic filler. In some embodiments, it comprises 40 wt. %-100 wt. % of inorganic materials different from quartz and cristobalite, based on the weight of the inorganic filler.

In some embodiments, the agglomerated composition or material comprises from 0 wt. %-30 wt. %, or even from 0 wt. %-10 wt. %, based on the weight of the agglomerated composition or material, of an inorganic material with a crystalline silica content in the range from 30 wt. %-100 wt. %.

In some embodiments, the crystalline silica (SiO₂) content of the agglomerated composition or material is from 0 wt. %-50 wt %, based on the weight of the agglomerated composition or material. In some embodiment, the content of crystalline silica in the agglomerated composition or material is from 0 wt. %-25 wt %, or even from 0 wt. %-10 wt %, based on the weight of the agglomerated composition or material.

In some embodiments, the agglomerated composition or material comprises at least 10 wt. % feldspar as inorganic filler based on the weight of the agglomerated composition or material. In an embodiment, the agglomerated composition or material comprises at least 25 wt. % feldspar, or at least 40 wt. % feldspar, as inorganic filler based on the weight of the agglomerated composition or material.

According to an embodiment, the agglomerated composition or material comprises from 10 wt. %-75 wt. % feldspar, based on the weight of the agglomerated composition or material. In another embodiment, it comprises from 15 wt. %-70 wt. % feldspar, based on the weight of the agglomerated composition or material.

In some embodiments, the inorganic filler comprises from 10 wt. %-95 wt % feldspar, based on the weight of the inorganic filler. In an embodiment, the inorganic filler comprises from 20 wt. %-95 wt % feldspar, or even from 50 wt. %-95 wt % feldspar, based on the weight of the inorganic filler.

In some embodiments, the feldspar present in the inorganic filler is sodium feldspar (NaAlSi₃O₈) or the mineral albite.

As used herein, the term “feldspar” designates a large group of crystalline minerals found in nature, formed by natural processes (e.g., metamorphism, or crystallization in slow-cooled rocks at high earth depths or from magma), and found in rocks. They are composed of monoclinic and triclinic silicates of aluminum with alkali or alkaline earth metals, commonly potassium, sodium, and calcium. Minerals in the feldspar group fit the formula: X(Al,Si)₄O₈, wherein X can be alkali or alkaline earth metal such as K, Na, Ca, Ba, Rb and Sr, generally Na, K and Ca. Examples of minerals coming within the term feldspar include plagioclase feldspars and alkali feldspars, such as andesine, albite, anorthoclase, anorthite, labradorite, microcline, orthoclase, oligoclase, sanidine and bytownite.

Additionally, or alternatively, the inorganic filler may comprise from 10 wt. %-95 wt. %, or from 20 wt. %-95 wt. % of silicate glass, synthetic silicate, or mixtures thereof.

Additionally, or alternatively, the agglomerated composition or material may comprise at least 10 wt. % glass, or at least 20 wt. % glass, as inorganic filler, based on the weight of the agglomerated composition or material. In an embodiment, the agglomerated composition or material comprises from 10 wt. %-70 wt. %, such as from 10 wt. %-60 wt. %, of glass as inorganic filler, based on the weight of the agglomerated composition or material.

As used herein, the term “glass” refers to any inorganic non-crystalline amorphous solid, including but not necessarily limited to silicate glasses, obtained from any source, including but not necessarily limited to pre-consumer and post-consumer waste streams, i.e., recycled glass.

The glass present in the inorganic filler is, for example, a silicate glass, or a borosilicate glass, or a sodium borosilicate glass. In some embodiments, the glass is post-industrial or post-commercial recycled glass or cullet, or it might be a glass frit.

In some embodiments, the inorganic filler comprises from 15 wt. %-95 wt % of feldspar and from 10 wt. %-70 wt % of glass, based on the weight of the inorganic filler.

The inorganic filler used in the agglomerated composition or material may be in the form of granules. In the present application, the term “granules” (or granulates) refers to material in the form of individual units (particles). Thus, the term encompasses units ranging from infinitesimal powder particulates with sizes on the micrometer scale to comparatively large particles of material with sizes on the millimeter scale. This term encompasses materials in the form of particles of various shapes and sizes, more or less edged or rounded, including grain particles, sort fibers, flakes, fines, powders, or combinations of these.

These inorganic fillers may be incorporated to the agglomerate mixture with different particle sizes. The inorganic filler in the agglomerated composition or material may be in the form of granules with a particle size in a range from 2.0 mm-0.065 mm (grain particles) or it might be lower than 65 micrometers (micronized powder). In the case of grain particles, the particle size might range from 1.2 mm-0.065 mm.

The desired particle size ranges (granulometry) of the inorganic fillers can be obtained by grinding and sieving/sorting, by methods known in the art, such as grinding with ball mills or opposed grinding rollers.

The inorganic filler materials (or inorganic fillers) can be sourced, for example, from specialized companies, which commercialize them already dry and classified according to their particle size.

The particle size, also called particle diameter, can be measured, for instance, by known screening separation using sieves of different mesh size. The term “particle size” as used herein, means the diameter of individual particles. It can be measured statistically by retention or passage of a population of particles on calibrated sieves having openings of known mesh size, where a particle will either pass through (and therefore be smaller than) or be retained by (and therefore be larger than) a given sieve. Particle sizes are defined to be within a certain size range determined by a particle's ability to pass through one sieve with larger mesh openings or ‘holes” and not pass through a second sieve with smaller mesh openings. In the instances along this description where an inorganic filler or material is said to have a particle size or a particle size in a given range, it is meant that less than 1% of particles, from the total particle population for this filler, have a particle size outside the given range. In an embodiment, less than 0.5% of particles, from the total particle population for this filler, have a particle size outside the given range. In a further embodiment, less than 0.1% of particles, from the total particle population for this filler, have a particle size outside the given range. For particles with a particle size<100 micrometers, the particle size distribution of a sample can be measured for example by laser diffraction, specifically with known commercial equipment (e.g., Malvern Panalytical Mastersizer 3000 provided with a Hydro cell). For the measurement, the sample might be dispersed in demineralized water assisted by an ultrasound probe. The laser diffractometer provides particle distribution curves (volume of particles vs. particle size) and the D10, D50 and D90 statistical values of the particle population of the sample (particle size values where 10%, 50% or 90% of the sample particle population lies below this value, respectively).

### Organic Resin

The terms hardened organic resin and organic resin (i.e., unhardened organic resin or hardenable organic resin) are well known in the art. Through this description, organic resin refers to the organic resin used as raw material, in uncured or unhardened state, to distinguish it from the hardened organic resin in the agglomerated material or article. According to an embodiment, organic resin or hardenable organic resin shall both be understood as a material of predominantly organic nature formed by a compound or a mixture of compounds, optionally together with a dilutant. The compound or the compounds in the mixture of compounds in the resin might be monomeric, oligomeric or polymeric, optionally with variable molecular weights and crosslinking degrees. At least some of the compounds in the hardenable organic resin, and optionally also the dilutant, will have functional reactive groups capable of undergoing hardening by solidifying, by a crosslinking or by a curing reaction that hardens the organic resin, resulting in a hardened organic resin (or hardened binder) upon completion of the curing step.

The organic resin of the various aspects herein is a binder compound that, once hardened, performs the function of holding together the (granular) filler material to form the agglomerated material or article. Generally speaking, the resin in unhardened or uncured form is mixed with the filler material, and subsequently hardened or cured to give cohesion and mechanical strength to the agglomerated material.

The organic resin, within the concept of the disclosure, may be thermosetting or thermoplastic. In certain embodiments, the organic resin is thermosetting, for example, an unsaturated polyester resin, an acrylic resin, a vinyl resin, or an epoxy resin. In some embodiments, the organic resin is an unsaturated polyester resin.

The unsaturated polyester resin can be obtained by polymerization of unsaturated dicarboxylic acids (or anhydrides) with diols. For example, by condensation of an acid or anhydride, such as maleic acid or maleic anhydride, fumaric acid, (ortho)phthalic acid or anhydride, isophthalic acid, terephthalic acid, adipic acid, succinic acid or anhydride, sebacic acid, or mixtures thereof, with a diol such as ethylene glycol, diethylene glycol, propylene glycol, butylene glycol, neopentyl glycol, hydrogenated bisphenol A, or mixtures thereof. The unsaturated polyester resin may also comprise an ethylenically unsaturated monomer as reactive dilutant, such as styrene, for example, in an amount of 25 wt. %-45 wt. % based on the weight of the resin.

In some embodiments, the unsaturated polyester resin is obtained by polymerization of a mixture comprising maleic acid and/or maleic anhydride, (ortho)phthalic acid and/or anhydride and propylene glycol.

In one embodiment, the unsaturated polyester resin comprises an unsaturated polyester prepolymer comprising the following monomer units: 20 wt. %-35 wt % by weight of (ortho)phthalic anhydride, isophthalic acid or mixtures thereof; 5 wt. %-20 wt % by weight of maleic anhydride, fumaric acid or mixtures thereof; 10 wt. %-25 wt % by weight of propylene glycol; 0 wt. %-15 wt % by weight of ethylene glycol; and 0 wt. %-15 wt % by weight of diethylene glycol; diluted with 25 wt. %-45 wt % by weight of styrene, based on the weight of the unsaturated polyester prepolymer.

In some embodiments, the agglomerated composition or the agglomerated material comprises from 5 wt. %-15 wt % of the (unhardened or hardened, respectively) organic resin, based on the weight of the agglomerated composition or material. In an embodiment, the amount of (unhardened or hardened) organic resin is from 6 wt. %-14 wt %, based on the weight of the agglomerated composition or material.

### Agglomerated Composition and Agglomerated Material

For clarity purposes, the term agglomerated composition as used herein refers to the composition resulting from the mixture of the raw materials used in the manufacture of the agglomerated material, i.e., before it is hardened or cured. On the other hand, agglomerated material refers to the hardened product or article obtained.

In addition to the inorganic filler, the organic resin and the Silanes A and B, the agglomerated composition or material may comprise additives, such as colorants or pigments, curing catalysts, curing accelerators, antimicrobial agents, UV stabilizers, rheology modifiers, or mixtures thereof. Other coupling agent precursors (e.g., silanes), different from Silane A and B, might be included in the composition or material as well. These types of additives and the proportion thereof are known in the state of the art. In some embodiments, these additional components or additives may be present in the agglomerated composition or material in an amount from 0.01 wt. %-5.0 wt. %, based on the weight of the agglomerated composition or material.

In an embodiment, the agglomerated composition or material according to the present disclosure comprises: from 70 wt. %-95 wt. % inorganic filler, from 5 wt. %-15 wt. % hardened organic resin, and from 0.02 wt. %-0.5 wt. % Silane A+Silane B, and optionally from 0.01 wt. %-5.0 wt. % additives such as selected from colorants, pigments, curing catalysts, curing accelerators, antimicrobial agents, UV stabilizers, rheology modifiers, other silanes different from Silane A and B, and mixtures thereof, based on the weight of the agglomerated composition or material.

In some embodiments, the composition or material according to the present disclosure does not comprise other silanes different from Silane A and Silane B.

In some embodiments, the agglomerated material has an apparent density in the range from 2000 kg/m³-2600 kg/m³, or from 2100 kg/m³-2500 kg/m³. Apparent density can be measured according to EN 14617-1:2013-08.

The agglomerated material may be in the form of a block, slab, tile, sheet, board, plate, plank or sheet.

The terms block, slab, tile, sheet, board, plate, plank and sheet as used herein are meant in general to an essentially flat and uniform thickness article, such as of square or rectangular parallelepiped form.

In an embodiment, the dimensions of the agglomerated material are at least 1500 mm in length, at least 1000 mm in width and from 4 mm-40 mm in thickness; such as from 2000 mm-3500 mm in length, from 1000 mm-1800 mm in width and from 4 mm-40 mm in thickness.

In some embodiments, the agglomerated material has a surface, such as at least one of its largest surfaces, polished, brushed, honed, buffed or sanded. In some embodiments, the agglomerated material has at least a polished surface, e.g., one or both of its largest surfaces.

The agglomerated material can be used for construction or decoration, for example for the manufacture of countertops, kitchen or vanity countertops, sinks, kitchen splashbacks, shower trays, wall or floor coverings, furniture cladding, tabletops, ventilated façade tiles, stovetops, profiles, fireplaces, stairs or the like.

Therefore, in another aspect, the disclosure is concerned with the use of an agglomerated material according to the present disclosure for the manufacture of a countertop, kitchen or vanity countertop, sink, kitchen splashback, shower tray, wall or floor covering, furniture cladding, tabletop, ventilated façade tile, stovetop, stair-step, or fireplace. In some embodiments, the agglomerated material is cut-to-size in the manufacture of these products.

In another aspect, the disclosure is directed to a countertop, kitchen or vanity countertop, sink, kitchen splashback, shower tray, wall or floor covering, furniture cladding, tabletop, ventilated façade tile, stovetop, stair-step or fireplace made from an agglomerated material according to the disclosure.

### Method of Manufacture

In another aspect, the disclosure refers to a method for the manufacture of an agglomerated material, comprising:
i) mixing a composition comprising an inorganic filler, an organic resin, Silane A and Silane B, to obtain an agglomerated composition,
ii) casting and/or compacting the agglomerated composition mixture obtained in i), and
iii) hardening the compacted agglomerated composition obtained in ii).

In another aspect, the disclosure is directed to an agglomerated material obtainable by the method of the disclosure.

In some embodiments, the inorganic filler, organic resin, Silane A, Silane B and the agglomerated composition comprising said components are as defined herein in relation to other aspects of the disclosure, such as the agglomerated material.

Mixing step i) can be performed, for example, by agitating and/or stirring the components with the use of conventional mixers, such as planetary mixers, in a known manner. Silanes A and B might be added jointly or separately to the composition comprising the inorganic filler and organic resin. Suitably, Silanes A and B are mixed together before contacting the organic resin and/or the inorganic filler, such as no longer than 10 days before, or no longer than 5 days before. The Silane A and Silane B are, for example, not substantially pre-reacted with themselves, with the inorganic filler, or with the organic resin, prior to their use in the manufacture of the agglomerated material. The Silanes A and/or B, or their mixture, are in an exemplified way of conducting the method, mixed with the organic resin before mixing with the inorganic filler.

Therefore, in an embodiment, Silane A and Silane B or their mixture is added to a composition comprising the inorganic filler and the organic resin. In another embodiment, a composition comprising Silane A, Silane B and the organic resin is added to the inorganic filler.

In addition to the inorganic filler, the organic resin and Silanes A and B, additives, such as colorants, pigments, curing catalysts, curing accelerators, antimicrobial agents, UV stabilizers, rheology modifiers, coupling agent precursors (e.g., silanes different from Silane A and B), or mixtures thereof, may be comprised in the (unhardened) agglomerated composition in step i). All these additives might be mixed together with the composition comprising the inorganic filler, organic resin, Silane A and Silane B in step i) to provide the agglomerated composition. Alternatively, some of the additives (e.g. colorants or pigments or a part thereof) might be added to the (unhardened) agglomerated composition obtained in step i), before step ii) is performed, for example if a particular aesthetic effect is desired.

In some embodiments, the additional components or additives may be present in the agglomerated composition in a total amount from 0.01 wt. %-5.0 wt. %, based on the weight of the agglomerated composition.

The (unhardened) agglomerated composition obtained after step i) can then be conveyed from the mixers to a distributing device. Suitable distributors are known, such as those used for the distribution of (non-hardened) agglomerated mixtures in the manufacture of quartz agglomerated surfaces. This distributing device is, for example, movable along the length of a temporary mold or a support sheet. Conveniently, the distributor device deposits the composition in the temporary mold or on the support sheet, forming with the (unhardened) composition a preform corresponding to the shape of the agglomerated material or article to be produced, with a slight excess in dimensions to compensate for possible shrinkage occurring during compaction and hardening. The supporting sheet, in its simplest form, might be embodied by a kraft paper or plastic sheet. Alternatively, it might be a more complex elastomeric mold tray. The dispensing device, for example, consists of a feeding hopper that receives the mixture at the upper opening thereof and a conveyor belt located below a lower outlet opening of the hopper, which collects or extracts the mixture from the hopper and deposits it on the support sheet or in the temporary mold. Other distribution devices are possible within the general concept of the disclosure.

The (unhardened) agglomerated composition that has been distributed in the mold or on the support sheet is, for example, covered with a protective film on its exposed surfaces and subjected to compaction in step ii), such as by vacuum vibrocompaction, to produce a compacted agglomerated mixture. For this purpose, in an example, the (unhardened) agglomerated composition is conveyed within a compaction zone of a press, wherein it is introduced into a sealable chamber. The chamber is then sealed and vacuum is created with suitable exhaust pumps. Once the desired vacuum level (e.g., 5 mbar-40 mbar) is reached, the press ram exerts a compaction pressure simultaneously with the application of a vertical vibration of the ram (e.g., oscillating at 2.000 Hz-4.000 Hz). During vacuum vibrocompaction, the air trapped in the agglomerated composition is substantially evacuated.

Alternatively, the mixing in step i) can be performed under vacuum, so that air is removed from the (unhardened) agglomerated composition. The (unhardened) agglomerated composition is then casted and/or compacted in step ii) to form a sheet, such as a continuous sheet on top of a surface on a conveyor belt.

The resulting casted and/or compacted agglomerated composition then passes to a hardening or curing step iii). The hardening of the organic resin, and thus of the mixture after casting and/or compaction, can ultimately be accelerated by raising the temperature, depending on the organic resin used, and/or by using suitable catalysts and accelerators as known in the art. Therefore, the hardening stage will depend on the type of organic resin used, as well as the use or not of catalysts or hardening accelerators, and their concentration. At this stage, the mixture is subjected to the effect of temperature in a curing oven, suitably heated to 40° C.-120° C., such as with residence times in the oven that can vary between 10 minutes and 90 minutes. After curing, the hardened compacted agglomerated mixture is cooled to a temperature equal to or below 40° C. Other types of hardening and curing are possible and within the present disclosure, such as hardening by application of radiation, such as UV-radiation.

During hardening, the Silanes A and/or B comprised in the agglomerated composition undergo reaction (which may include hydrolysis, condensation, polymerization, deposition, esterification, etc.) either with the inorganic filler, the organic resin and/or with themselves, and thereby coupling (or bonding, adhering, anchoring) the inorganic granules and the organic resin. The agglomerated material obtained comprises the coupling agent derived from, or the reaction product of, the Silane A and/or Silane B.

After hardening stage iii), the obtained agglomerated material may be in any desired form, for instance, in the form of blocks, slabs, slabs, plates, tiles, boards, planks or sheets, and may be cut and/or calibrated to the desired final dimensions depending on the intended application. The agglomerated material may also have more complex shapes, and may include curved parts, such as sinks, basins or shower trays. In one embodiment, the dimensions of the agglomerated material are at least 1500 mm in length, at least 1000 mm in width and from 4 mm-40 mm in thickness; such as from 2000 mm-3500 mm in length, from 1000 mm-1800 mm in width and from 4 mm-40 mm in thickness.

The method of the disclosure also comprises a surface finishing step after step iii), e.g., to provide a glossy or smooth finish to the agglomerate material, which might include polishing, brushing, honing, buffing or sanding. The method of disclosure, for example, comprises a polishing step after step iii). In embodiments, the method additionally comprises a surface finishing step after step iii), on one or several of its surfaces, depending on the intended application. Said surface finishing step may be performed on at least one of the surfaces of the agglomerated material, for example, at one or both of its largest surfaces.

### EXAMPLES

### Testing Methods:

XRD: The identification and quantification of crystalline phases, such as crystalline silica, can be done by powder X-ray diffraction (XRD) analysis, such as using the Rietveld method, combined with the use of an internal standard for quantification, a technique widely used in the technological field. This method also allows quantification of the overall amorphous phase. As an example, one way of performing the analysis is described. The internal standard methodology requires a known amount of reference standard (corundum, for example) to be thoroughly mixed and homogenized with the sample to be analyzed, optionally employing a small amount of isopropanol or other mixing-homogenization adjuvant. A Ge(111) monochromator generating CuK1 radiation and an X'Celerator detector from commercial equipment (e.g., PANalytical X'Pert Pro automated diffractometer) may be used. X-ray diffraction patterns of the powder may be recorded between 4°-70° in 2θ to 60 s/step, while rotating to increase the statistical distribution of the particles. Once the powder X-ray diffraction data is obtained, software (e.g., Brucker's DIFFRAC.EVA) can be used to perform identification of the crystalline phases by comparison with the cataloged diffraction patterns. Quantification of crystalline and amorphous phases can be performed with the Rietveld refinement method, e.g., using TOPAS software (from Coelho Software). The content of the crystalline phases and the overall amorphous phase is calculated as a weight percentage of the analyzed sample, after subtraction of the amount of the internal standard used.

The colorimetry and transparency of the hardened mixtures of inorganic filler, organic resin and silanes, was determined as follows: 50 g of activated unsaturated polyester resin (resin+1.2 wt. % of peroxide, and 0.125 wt. % cobalt accelerator), 50 g of inorganic filler material (if used) and 1 g of silane (or silane mixture) were mixed until homogenized, before adding 0.75 g of peroxide catalyst under stirring at room temperature. The mixture was poured into a mold and hardened for 30 minutes in a convection oven at 70° C., so that discs of a defined thickness were obtained. The colorimetry of the hardened mixtures was measured with a Konica Minolta CM-3600d or similar spectrophotometer, after removal from the mold, on the surface that was downward during hardening. The averaged result of three measurements is given as L*, a* and b* coordinates in the CIE Lab color space. Transparency can be measured on the same disks with a commercial transparency analyzer (e.g., from Sensure SRL) capable of measuring the proportion of white light transmitted through the disk.

Hydrolysis resistance of the agglomerated material was quantified as the CIE Lab total color difference (ΔE*) before and after accelerated ageing of material samples. The chromatic L1*, a1* and b1* coordinates were measured with a spectrophotometer (e.g., Konica Minolta CM-3600d or similar) on the surface of a sample, such as the surface being polished or having any other finishing. Then, for accelerating ageing, the sample was immersed in a water bath set at the predefined hydrolysis temperature. After a period of 7 days, the samples were removed from the bath and dried, and the chromatic L2*, a2* and b2* coordinates were measured again. The total color difference (ΔE*) was calculated as known in the art, e.g. with the following formula.

ΔE*=\sqrt{(L*₂−L*₁)²+(a*₂−a*¹)²+(b*₂−b*₁)²}

The value ΔE* is a measure of the degree of hydrolysis suffered by the sample, the higher the value, the more the hydrolysis progressed.

The hardening or curing reaction rate of the organic resin mixed with silanes was determined as follows. A defined amount of resin, inorganic filler, silane, peroxide initiator and cobalt accelerator were added to a sample tube. The amount of silane was 2 wt. % relative to the resin, and the amounts of initiator and accelerator were around 2 wt. % and 0.2 wt. % respectively. The type and content of inorganic filler might be varied and were representative of the amounts in the agglomerated material. Mixture was homogenized and the sample tube immersed in a water bath set at 80° C. The temperature of the mixture was monitored with a thermocouple inserted into the mixture and registered versus time. The maximum temperature reached (Tₘₐₓ) and the time needed to reach the maximum temperature (t_{Tmax}) were noted. The gel time was calculated as the time the mixture needs to go from 65° C. to 95° C. (t₆₅₋₉₅).

### Experiments:

The hardening reaction of mixtures of two commercial unsaturated polyester resins (UPR1 and UPR2, 60 wt. %) with 40 wt. % post-industrial recycled silicate glass filler having a particle size<200 micrometers was compared, following the method described above, and including in the mixtures 2.0 wt. % in relation to the resin weight of a silane selected from 3-methacryloxypropyl-trimethoxysilane (Silane B1), di-t-butoxy-di-acetoxysilane (Silane A1), or a mixture of both. The results of Tₘₐₓ, t_{Tmax} and t₆₅₋₉₅ are presented in Table 1.

TABLE 1

| Example | Resin | Silane | Tₘₐₓ | t_{Tmax} | t₆₅₋₉₅ |
|---|---|---|---|---|---|
| 1* | UPR1 | Silane B1 | 143° C. | 15 min 55 s | 6 min 59 s |
| 2* | UPR1 | Silane A1 | 147° C. | 17 min 12 s | 6 min 0 s |
| 3* | UPR2 | Silane B1 | 157° C. | 16 min 25 s | 5 min 13 s |
| 4 | UPR2 | Silane A1:Silane B1 | 158° C. | 16 min 38 s | 5 min 9 s |
| | | (25:75)^{†} | | | |

Table 1 (*denotes comparative examples,
^{†}numbers in brackets are weight % ratios in case of mixtures)

The values in Table 1 demonstrate that the use of Silane A1 alone delays significantly the hardening reaction of the resin mixtures with glass filler. However, using a mixture of Silane A1 and Silane B1 in 25:75 weight ratio does not affect significantly the hardening reaction profile.

The hardening reaction of resins comprising di-benzyloxy-di-acetoxysilane (Silane A2) was also evaluated as described above. In this case, a commercial unsaturated resin (UPR2′), in absence of any inorganic filler, was mixed with either 2.0 wt. % of Silane B1 in relation to the resin weight, or with 2.0 wt. % of a mixture of Silane A2:Silane B1 (25:75 weight ratio) in relation to the resin weight. The values of Tₘₐₓ, t_{Tmax} and t₆₅₋₉₅ presented in Table 1′ support the fact that the presence of Silane A2 does not significantly affect the hardening profile of the resin.

TABLE 1′

| Example | Resin | Silane | Tₘₐₓ | t_{Tmax} | t₆₅₋₉₅ |
|---|---|---|---|---|---|
| 1′* | UPR2′ | Silane B1 | 195° C. | 12 min 06 s | 2 min 06 s |
| 2′ | UPR2′ | Silane A2:Silane B1 | 196° C. | 13 min 12 s | 1 min 48 s |
| | | (25:75)^{†} | | | |

Table 1′ (*denotes comparative examples,
^{†}numbers in brackets are weight % ratios in case of mixtures)

In further comparative examples, the colorimetry of hardened mixtures of three different unsaturated polyester resins—UPR3, UPR4 and UPR5—mixed with 2 wt. % in relation to the resin weight of either Silane A1 or Silane B1, was measured as described above. In all cases, it was observed that the incorporation of either Silane A1 or Silane B1 affects equally the colorimetry of the resulting hardened mixture, with only minor deviations from the obtained L*, a* or b* color coordinates. Although being comparative, these examples support the fact that variation of the proportions of Silane A1 and Silane B1 in mixtures with organic resin would not need significant adjustments of pigmentation to achieve substantially the same color tones in the final agglomerated material.

Agglomerated tiles of 30×30 cm², 2.0 cm thick, were prepared by vacuum vibrocompaction from compositions comprising felspar granulates, glass granulates, organic resin and a silane (or mixtures of silanes).

For the manufacture of these agglomerated tiles, an unhardened agglomerated composition was prepared comprising about 67.8 wt. % of sodium feldspar, 20.4 wt. % of post-industrial recycled glass, and 0.3 wt. % of silane (or silane mixture), with the rest 11.5 wt. % until 100 wt. % being pigmented and activated unsaturated polyester resin (UPR). The UPR included dissolved 1.0 wt. %-2.0 wt. % of peroxide catalyst and 0.1 wt. %-0.2 wt. % of cobalt salt accelerator, and 1.5 wt. % pigments in relation to the weight of the resin. The process was as follows: The unhardened agglomerated composition was deposited homogeneously distributed between two sheets of Kraft paper and was vibrocompacted under vacuum in a press suitable for this purpose, until most of the included air was extracted. Subsequently, the mixture was placed in an oven at 90° C. for 45 minutes to react the mixture. When the hardened agglomerate tile was removed from the oven, it was calibrated to remove the paper sheets and one of the larger surfaces of the tile was polished.

In these examples, five different unsaturated polyester resins from different suppliers—UPR6, UPR7, UPR8, UPR9, UPR10 and UPR11—resulting in different mechanical and chemical properties after hardening, were used. The silane employed was either Silane A1, Silane B1, or a mixture of Silane A1:Silane B1 in different weight ratios. Silane A2 being di-benzyloxy-di-acetoxysilane, or a mixture of Silane A2:Silane B1, was employed in additional experiments. The rest of the composition components, including pigments, hardening catalyst (peroxide) and accelerator (cobalt salt), remained unchanged among the examples. The hydrolysis resistance of the agglomerated tiles was measured on the polished tile surfaces as described above, by immersing samples of the tiles at 85° C. for 7 days. The results are shown in Table 2.

TABLE 2

| | | | Total |
|---|---|---|---|
| | | | color change |
| Example | Resin | Silane | (ΔE*) |
| 5* | UPR6 | Silane B1 | 6.5 |
| 6 | UPR6 | Silane A1:Silane B1 | 4.3 |
| | | (25:75)^{†} | |
| 7* | UPR7 | Silane B1 | 10.6 |
| 8 | UPR7 | Silane A1:Silane B1 | 7.8 |
| | | (25:75)^{†} | |
| 9* | UPR8 | Silane B1 | 13.8 |
| 10 | UPR8 | Silane A1:Silane B1 | 10.1 |
| | | (25:75)^{†} | |
| 11* | UPR9 | Silane B1 | 10.8 |
| 12 | UPR9 | Silane A1:Silane B1 | 10.5 |
| | | (10:90)^{†} | |
| 13 | UPR9 | Silane A1:Silane B1 | 6.1 |
| | | (25:75)^{†} | |
| 14 | UPR10 | Silane B1 | 8.3 |
| 15 | UPR10 | Silane A1:Silane B1 | 6.9 |
| | | (25:75)^{†} | |
| 16 | UPR10 | Silane A1 | 24.6 |
| 17 | UPR11 | Silane B1 | 17.2 |
| 18 | UPR11 | Silane A1:Silane B1 | 14.9 |
| | | (25:75)^{†} | |
| 19 | UPR11 | Silane A2:Silane B1 | 15.4 |
| | | (25:75)^{†} | |
| 20 | UPR12 | Silane A2 | 19.9 |

Table 2 (*denotes comparative examples,
^{†}numbers in brackets are weight % ratios in case of mixtures)

The results in Table 2 evidence that the tiles incorporating the coupling agent according to the disclosure present a significant improvement compared to the use of Silane B1, Silane A2 or Silane A1 alone, in their resistance to hydrolysis, irrespective of the resin used, leading to a reduction in the total color change of up to 44% after accelerated ageing.

In additional examples directed to compare the hydrolysis resistance of industrially manufactured slabs, agglomerated slabs having 325×159 cm² size, and 2 cm thickness, were produced in an industrial setting in the production lines of Silestone® owned by the applicant's group of companies, following the vacuum vibrocompactation and heat curing method generally described in this specification. One of the major surfaces of the slabs was polished. In these industrial trials, an unhardened agglomerated composition was prepared mixing around 11.9 wt. % of a commercial pigmented activated unsaturated polyester resin, with about 46.7 wt. % synthetic cristobalite, about 18.6 wt. % of sodium feldspar, about 22.5 wt. % post-industrial recycled glass. The unsaturated polyester resin included 1 wt. %-2 wt. % of peroxide catalyst and 0.1 wt. %-0.2 wt. % cobalt salt accelerator in relation to the resin weight. Pigments were included also dissolved in the resin in a concentration 0.1 wt. %-1.0 wt. % related to the weight of the agglomerated composition. Additionally, approximately 0.3 wt. % of either Silane B1 alone, or of a mixture of 25 wt. % Silane A1:75 wt. % Silane B1 related to the weight of the agglomerated composition was incorporated into the mixture.

The hydrolysis resistance after accelerated ageing at 85° C. of the industrial slabs obtained was evaluated as described above, and the results are shown in Table 3.

TABLE 3

| | | Total |
|---|---|---|
| | | color change |
| Example | Silane | (ΔE*) |
| 21* | Silane B1 | 8.0 |
| 22 | Silane A1:Silane B1 | 6.5 |
| | (25:75)^{†} | |

Table 3. (*denotes comparative examples,
^{†}numbers in brackets are weight % ratios in case of mixtures)

The results from the industrial slabs confirm the improvement in hydrolysis resistance when the silane mixture according to the claims is employed.

In further examples intended to evaluate the behavior during polishing of agglomerated articles, series of slabs having 325×159 cm² size and 2 cm thickness were manufactured in an industrial setting following the same protocol as in examples 17-18. However, in this case, the unhardened agglomerated composition comprised around 55.8 wt. % sodium feldspar, 34.9 wt. % quartz and about 9.0 wt. % of a commercial unsaturated polyester resin previously pigmented and activated. The unsaturated polyester resin included 1 wt. %-2 wt. % of peroxide catalyst and 0.1 wt. %-0.2 wt. % cobalt salt accelerator in relation to the resin weight. Pigments were included also dissolved in the resin in a concentration 0.1 wt. %-1.0 wt. % related to the weight of the agglomerated composition. In comparative example 19, 0.3 wt. % of Silane B1 was incorporated into the mixture. On the other hand, in inventive example 20, 0.3 wt. % of a mixture of Silane A1:Silane B1 in 25:75 wt. % ratio related to the weight of the agglomerated composition was incorporated into the mixture.

The top major surface of the series of hardened agglomerated slabs in example 19 and 20 was polished following the same polishing sequence. It was found that the slabs of example 20 could be polished at a much higher line speed to achieve the same level of gloss as in example 19, without suffering from a higher occurrence of polishing defects (such as scratches, pores, burns, shading, etc.). The polishing speed in example could be increased to 1.15 m/min, while in example 19 it could not be increased over 0.9 m/min without producing unacceptable levels of critical defects or rejects.

1. An agglomerated material comprising:
an inorganic filler,
a hardened organic resin, and
a coupling agent,
wherein the coupling agent results from the reaction of a mixture comprising Silane A and Silane B, wherein Silane A has the following formula:
Si(—OCOR¹)ₓ(—R²)_{y}
wherein
x is 1, 2 or 3,
y is 1, 2 or 3,
x+y is 4;
each R¹ is independently a group of formula CₙH₂ₙ₊₁, wherein n is 1, 2 or 3; and
each R² is independently selected from a group of formula CₘH₂ₘ₊₁, —OCₚH₂ₚ₊₁, Ph and —CH₂-Ph, wherein m is 3, 4, 5 or 6 and p is 3, 4, 5 or 6;
and Silane B is an alkoxysilane or an acyloxysilane comprising a substituent, different to the alkoxy or acyloxy substituents, directly linked to the silicon atom, having a functional group capable of reacting with the organic resin.

2. The agglomerated material according to claim 1, wherein x=2, y=2 and each R² is independently selected from a group of formula —OCₚH₂ₚ₊₁, wherein p is 3, 4, 5 or 6, or —O—CH₂-Ph.

3. The agglomerated material according to claim 1, wherein Silane A is selected from the group consisting of di-t-butoxy-diacetoxysilane, di-isobutoxy-diacetoxysilane, di-isopropoxy-diacetoxysilane, di-phenyl-di-acetoxysilane, di-phenoxy-di-acetoxysilane, di-benzyl-di-acetoxysilane, di-benzyloxy-di-acetoxysilane, di-t-butyl-diacetoxysilane, di-isobutyl-diacetoxysilane, di-isopropyl-diacetoxysilane, di-t-butoxy-dipropionoxysilane, di-isopropoxy-dipropionoxysilane, 2-ethylbutoxy-diacetoxysilane, di-t-pentoxy-diacetoxysilane, and mixtures thereof.

4. The agglomerated material according to claim 1, wherein Silane B has the following formula:
Si(—ZR³)₃(-L-R⁴)
wherein
each Z is independently absent, —O—, or —OCO—, provided that at least one Z is selected from —O— and —OCO—;
each R³ is independently selected from a group of formula C_{q}H_{2q+1}, wherein q is 1, 2, 3 or 4;
L is a C₁₋₅ alkyl chain optionally interrupted by one oxygen atom; and
R⁴ is selected from vinyl, acryloxy, methacryloxy, epoxy and anhydride.

5. The agglomerated material according to claim 1, wherein Z is —O— and R⁴ is selected from a group of formula —CH═CH₂, —OCOCH═CH₂, —OCOC(CH₃)═CH₂, 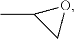
and —C(O)—O—C(O)—R⁵, wherein R⁵ is a group of formula CᵣH₂ᵣ₊₁, wherein r is 1, 2, 3 or 4.

6. The agglomerated material according to claim 1, wherein Silane B is selected from 3-methacryloxypropyl-trimethoxysilane, 3-methacryloxypropyl-triethoxysilane, 3-methacryloxypropyl-methyldimethoxysilane and acryloxypropyl-trimethoxysilane.

7. The agglomerated material according to claim 1, wherein Silane A is di-t-butoxy-diacetoxysilane or di-benzyloxy-di-acetoxysilane and Silane B is 3-methacryloxypropyl-trimethoxysilane.

8. The agglomerate material according to claim 1, wherein the weight ratio of Silane A:Silane B ranges from 15:95-75:25.

9. The agglomerated material according to claim 1, wherein the resin is an unsaturated polyester resin.

10. The agglomerated material according to claim 1, wherein the content of crystalline silica is ≤50 wt %, based on the weight of the agglomerated material or agglomerated composition.

11. An agglomerated material composition comprising
an inorganic filler,
an organic resin,
Silane A and Silane B, wherein Silane A has the following formula:
Si(—OCOR¹)ₓ(—R²)_{y}
wherein
x is 1, 2 or 3,
y is 1, 2 or 3,
x+y is 4;
each R¹ is independently a group of formula CₙH₂ₙ₊₁, wherein n is 1, 2 or 3; and
each R² is independently selected from a group of formula CₘH₂ₘ₊₁, —OCₚH₂ₚ₊₁, Ph, O-Ph, O—CH₂-Ph and —CH₂-Ph, wherein m is 3, 4, 5 or 6 and p is 3, 4, 5 or 6;
and Silane B is an alkoxysilane or an acyloxysilane comprising a substituent, different to the alkoxy or acyloxy substituents, directly linked to the silicon atom, having a functional group capable of reacting with the organic resin.

12. The agglomerated material composition according to claim 11, wherein x=2, y=2 and each R² is independently selected from a group of formula —OCₚH₂ₚ₊₁, wherein p is 3, 4, 5 or 6, or —O—CH₂-Ph.

13. The agglomerated material composition according to claim 11, wherein Silane A is selected from the group consisting of di-t-butoxy-diacetoxysilane, di-isobutoxy-diacetoxysilane, di-isopropoxy-diacetoxysilane, di-phenyl-di-acetoxysilane, di-phenoxy-di-acetoxysilane, di-benzyl-di-acetoxysilane, di-benzyloxy-di-acetoxysilane, di-t-butyl-diacetoxysilane, di-isobutyl-diacetoxysilane, di-isopropyl-diacetoxysilane, di-t-butoxy-dipropionoxysilane, di-isopropoxy-dipropionoxysilane, 2-ethylbutoxy-diacetoxysilane, di-t-pentoxy-diacetoxysilane, and mixtures thereof.

14. The agglomerated material composition according to claim 11, wherein Silane B has the following formula:
Si(—ZR³)₃(-L-R⁴)
wherein
each Z is independently absent, —O—, or —OCO—, provided that at least one Z is selected from —O— and —OCO—;
each R³ is independently selected from a group of formula C_{q}H_{2q+1}, wherein q is 1, 2, 3 or 4;
L is a C₁₋₅ alkyl chain optionally interrupted by one oxygen atom; and
R₄ is selected from vinyl, acryloxy, methacryloxy, epoxy and anhydride.

15. The agglomerated material composition according to claim 11, wherein Z is —O— and R⁴ is selected from a group of formula —CH═CH₂, —OCOCH═CH₂, —OCOC(CH₃)═CH₂, 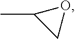
and —C(O)—O—C(O)—R⁵, wherein R⁵ is a group of formula CᵣH₂ᵣ₊₁, wherein r is 1, 2, 3 or 4.

16. The agglomerated material composition according to claim 11, wherein Silane B is selected from 3-methacryloxypropyl-trimethoxysilane, 3-methacryloxypropyl-triethoxysilane, 3-methacryloxypropyl-methyldimethoxysilane, and acryloxypropyl-trimethoxysilane.

17. The agglomerated material composition according to claim 11, wherein Silane A is di-t-butoxy-diacetoxysilane and Silane B is 3-methacryloxypropyl-trimethoxysilane.

18. The agglomerated material composition according to claim 11, wherein the weight ratio of Silane A:Silane B ranges from 15:95-75:25.

19. The agglomerated material composition according to claim 11, wherein the resin is an unsaturated polyester resin.

20. The agglomerated material composition according to claim 11, wherein the content of crystalline silica is ≤50 wt %, based on the weight of the agglomerated material or agglomerated composition.

21. A silane mixture comprising Silane A and Silane B, wherein Silane A has the following formula:
Si(—OCOR¹)ₓ(—R²)_{y}
wherein
x is 1, 2 or 3,
y is 1, 2 or 3,
x+y is 4;
each R¹ is independently a group of formula CₙH₂ₙ₊₁, wherein n is 1, 2 or 3; and
each R² is independently selected from a group of formula CₘH₂ₘ₊₁, —OCₚH₂ₚ₊₁, Ph and —CH₂-Ph, wherein m is 3, 4, 5 or 6 and p is 3, 4, 5 or 6;
and Silane B is an alkoxysilane or an acyloxysilane comprising a substituent, different to the alkoxy or acyloxy substituents, directly linked to the silicon atom, having a functional group capable of reacting with the organic resin.

22. The silane mixture according to claim 21, wherein x=2, y=2 and each R² is independently selected from a group of formula —OCₚH₂ₚ₊₁, wherein p is 3, 4, 5 or 6.

23. The silane mixture according to claim 21, wherein Silane A is selected from the group consisting of di-t-butoxy-diacetoxysilane, di-isobutoxy-diacetoxysilane, di-isopropoxy-diacetoxysilane, di-phenyl-di-acetoxysilane, di-benzyl-di-acetoxysilane, di-t-butyl-diacetoxysilane, di-isobutyl-diacetoxysilane, di-isopropyl-diacetoxysilane, di-t-butoxy-dipropionoxysilane, di-isopropoxy-dipropionoxysilane, 2-ethylbutoxy-diacetoxysilane, di-t-pentoxy-diacetoxysilane, and mixtures thereof.

24. The silane mixture according to claim 21, wherein Silane B has the following formula:
Si(—ZR³)₃(-L-R⁴)
wherein
each Z is independently absent, —O—, or —OCO—, provided that at least one Z is selected from —O— and —OCO—;
each R³ is independently selected from a group of formula C_{q}H_{2q+1}, wherein q is 1, 2, 3 or 4;
L is a C₁₋₅ alkyl chain optionally interrupted by one oxygen atom; and
R⁴ is selected from vinyl, acryloxy, methacryloxy, epoxy and anhydride.

25. The silane mixture according to claim 3, wherein Z is —O— and R⁴ is selected from a group of formula —CH═CH₂, —OCOCH═CH₂, —OCOC(CH₃)═CH₂, 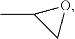
and —C(O)—O—C(O)—R⁵, wherein R⁵ is a group of formula CᵣH₂ᵣ₊₁, wherein r is 1, 2, 3 or 4.

26. The silane mixture according to claim 21, wherein Silane B is selected from 3-methacryloxypropyl-trimethoxysilane, 3-methacryloxypropyl-triethoxysilane, 3-methacryloxypropyl-methyldimethoxysilane, and acryloxypropyl-trimethoxysilane.

27. The silane mixture according to claim 21, wherein Silane A is di-t-butoxy-diacetoxysilane or di-benzyloxy-di-acetoxysilane and Silane B is 3-methacryloxypropyl-trimethoxysilane.

28. The silane mixture according to claim 21, wherein the weight ratio of Silane A:Silane B ranges from 15:95-75:25.

29. A method for manufacturing an agglomerated material, the method comprising:
i) mixing a composition comprising an inorganic filler, an organic resin, Silane A and Silane B, to obtain an agglomerated composition,
ii) casting, compacting, or combination thereof of an agglomerated composition mixture obtained in i), and
iii) hardening the compacted agglomerated composition obtained in ii);
wherein Silane A has the following formula:
Si(—OCOR¹)ₓ(—R²)_{y}
wherein
x is 1, 2 or 3,
y is 1, 2 or 3,
x+y is 4;
each R¹ is independently a group of formula CₙH₂ₙ₊₁, wherein n is 1, 2 or 3; and
each R² is independently selected from a group of formula CₘH₂ₘ₊₁, —OCₚH₂ₚ₊₁, Ph, —O-Ph, —O—CH₂-Ph and —CH₂-Ph, wherein m is 3, 4, 5 or 6 and p is 3, 4, 5 or 6; and
and Silane B is an alkoxysilane or an acyloxysilane comprising a substituent linked to the silicon atom, different to the alkoxy or acyloxy substituents, having a functional group capable of reacting with the organic resin.
